(19) United States
(12) Patent Application Publication
(10) Pub. No.: US 2026/0229124 A1
(43) Pub. Date: Aug. 6, 2026

(54) SITUATION-AWARE DYNAMIC TRAILER LIGHTS COMBINED WITH ADAS VEHICLE FUNCTIONALITY OF A SEMI-TRUCK

(71) Applicant: Torc Robotics, Inc., Blacksburg, VA (US)

(72) Inventors: Maximilian Koeper, Baden-Wurttemberg (DE); Stefan Koch, Baden-Württemberg (DE); David Unger, Baden-Württemberg (DE)

(21) Appl. No.: 19/044,987

(22) Filed: Feb. 4, 2025

(51) Int. Cl. G08G 1/16; B60Q 1/50; B60W 60/00; H05B 47/105

(52) U.S. Cl. CPC G08G 1/16; B60Q 1/507; B60Q 1/525; B60W 60/00; H05B 47/105; B60Q 2400/20

(57) ABSTRACT

An autonomous vehicle (AV) is disclosed, comprising one or more tires, at least one or more sensors, a memory storing machine-executable instructions, and at least one processor. The sensors are configured to collect data related to vehicles in the surrounding environment of the AV, specifically near the trailer as the AV navigates a route. The processor executes the stored instructions to receive and analyze sensor data to detect vehicles within proximity to the trailer that may pose a collision risk. Based on this analysis, the system predicts the specific part of the trailer likely to be impacted if the detected vehicles continue along their predicted trajectory. The system then dynamically activates warning lights on the trailer, illuminating only the section corresponding to the predicted collision area, thereby providing targeted visual alerts to surrounding vehicles. This method enhances road safety by mitigating collision risks and improving situational awareness for nearby drivers.

### TECHNICAL FIELD

The field of the disclosure pertains to systems and methods for enhancing vehicle safety by integrating advanced driver-assistance systems (ADAS) functionality with trailer-mounted warning lights in semi-trucks operating as autonomous vehicles.

### BACKGROUND OF THE INVENTION

Autonomous vehicles employ fundamental technologies such as, perception, localization, behaviors and planning, and control. Perception technologies enable an autonomous vehicle to sense and process its environment. Perception technologies process a sensed environment to identify and classify objects, or groups of objects, in the environment, for example, pedestrians, vehicles, or debris. Localization technologies determine, based on the sensed environment, for example, where in the world, or on a map, the autonomous vehicle is. Localization technologies process features in the sensed environment to correlate, or register, those features to known features on a map. Localization technologies may rely on inertial navigation system (INS) data. Behaviors and planning technologies determine how to move through the sensed environment to reach a planned destination. Behaviors and planning technologies process data representing the sensed environment and localization or mapping data to plan maneuvers and routes to reach the planned destination for execution by a controller or a control module. Controller technologies use control theory to determine how to translate desired behaviors and trajectories into actions undertaken by the vehicle through its dynamic mechanical components. This includes steering, braking and acceleration.

Controller technologies in autonomous vehicles are critically tasked with detecting and analyzing actions and maneuvers performed by the vehicle to assess the proximity of objects or other vehicles near the trailer that could pose safety risks. These systems can continuously monitor operational patterns and environmental data to identify potential hazards, such as nearby obstacles or roadway users, which could lead to unsafe conditions. It is essential that these technologies not only detect objects within the trailer's vicinity but also accurately classify the type and level of risk posed by such objects or vehicles. This capability allows the system to execute targeted responses, such as adjusting speed, modifying the vehicle's trajectory, or activating warning systems to mitigate safety risks. By accurately determining the presence and nature of nearby hazards and responding appropriately, these controller systems enhance the operational safety and reliability of autonomous vehicles, particularly in complex or dynamic driving environments.

This section is intended to introduce the reader to various aspects of art that may be related to various aspects of the present disclosure described or claimed below. This description is believed to be helpful in providing the reader with background information to facilitate a better understanding of the various aspects of the present disclosure. Accordingly, it should be understood that these statements are to be read in this light and not as admissions of prior art.

### SUMMARY OF THE INVENTION

In one aspect, the disclosed technology relates to a computing system for alerting vehicles in proximity of a trailer of an autonomous vehicle (AV), the system including: at least one memory configured to store machine-executable instructions; and at least one processor coupled to the at least one memory and configured to execute the machine-executable instructions to: receive data from a one or more sensors positioned at one or more locations on the AV, the one or more sensors configured to detect one or more vehicles in surrounding areas of the trailer of the AV as the AV is navigating a route; detect, based on the data received from the plurality of sensors, one or more vehicles within a proximity of the trailer that may potentially collide with the trailer; determine, based on the data received a predicted part of the trailer that is likely to be collided with if the one or more vehicles continue along a predicted route; and illuminate one or more warning lights on the trailer, wherein the illuminated warning lights correspond to the predicted part of the trailer that is likely to be collided with by the one or more vehicles.

In another aspect, the disclosed herein relates to an autonomous vehicle (AV), including: one or more tires; at least one or more sensors configured to collect data related to one or more vehicles in an environment surrounding the AV; a memory configured to store machine executable instructions; and at least one processor configured to execute the stored executable instructions to: receive data from a one or more sensors positioned at one or more locations on the AV, the one or more sensors configured to detect one or more vehicles in surrounding areas of the trailer of the AV as the AV is navigating a route; detect, based on the data received from the plurality of sensors, one or more vehicles within a proximity of the trailer that may potentially collide with the trailer; determine, based on the data received a predicted part of the trailer that is likely to be collided with if the one or more vehicles continue along a predicted route; and illuminate one or more warning lights on the trailer, wherein the illuminated warning lights correspond to the predicted part of the trailer that is likely to be collided with by the one or more vehicles.

In yet another aspect, the disclosed technology relates to a method including: receiving data from a one or more sensors positioned at one or more locations on the AV, the one or more sensors configured to detect one or more vehicles in surrounding areas of the trailer of the AV as the AV is navigating a route; detecting, based on the data received from the plurality of sensors, one or more vehicles within a proximity of the trailer that may potentially collide with the trailer; determining, based on the data received a predicted part of the trailer that is likely to be collided with if the one or more vehicles continue along a predicted route; and illuminating one or more warning lights on the trailer, wherein the illuminated warning lights correspond to the predicted part of the trailer that is likely to be collided with by the one or more vehicles.

Various refinements exist of the features noted in relation to the above-mentioned aspects. Further features may also be incorporated in the above-mentioned aspects as well. These refinements and additional features may exist individually or in any combination. For instance, various features discussed below in relation to any of the illustrated examples may be incorporated into any of the above-described aspects, alone or in any combination.

### BRIEF DESCRIPTION OF DRAWINGS

The following drawings form part of the present specification and are included to further demonstrate certain aspects of the present disclosure. The disclosure may be better understood by reference to one or more of these drawings in combination with the detailed description of specific embodiments presented herein.

FIG. 1. is a schematic view of an autonomous truck according to some aspects of the present technology;

FIG. 2 is a block diagram of the autonomous truck shown in FIG. 1, according to some aspects of the present technology;

FIG. 3 illustrates an autonomous vehicle connected to a trailer configured to illuminate trailer-mounted warning lights according to some aspects of the present disclosure.

FIG. 4 illustrates an example left turn maneuver of an autonomous vehicle causing the illumination of warning lights of a connected trailer to alert a vehicle within close proximity according to some aspects of the present technology.

FIG. 5 illustrates an example right turn maneuver of an autonomous vehicle causing the illumination of warning lights of a connected trailer to alert a vehicle within close proximity according to some aspects of the present technology.

FIG. 6 illustrates an example lane change maneuver of an autonomous vehicle causing the illumination of warning lights of a connected trailer to alert a vehicle within close proximity according to some aspects of the present technology.

FIG. 7 is a flow diagram of an example embodiment method for alerting vehicles in proximity of a trailer of an autonomous vehicle (AV) according to some aspects of the present disclosure.

FIG. 8 is a block diagram of an example computing system according to some aspects of the present technology.

Corresponding reference characters indicate corresponding parts throughout the several views of the drawings. Although specific features of various examples may be shown in some drawings and not in others, this is for convenience only. Any feature of any drawing may be referenced or claimed in combination with any feature of any other drawing.

Some structural or method features may be shown in specific arrangements and/or orderings in the drawings. However, it should be appreciated that such specific arrangements and/or orderings may not be required. Rather, in some embodiments, such features may be arranged in a different manner and/or order than shown in the illustrative figures. Additionally, the inclusion of a structural or method feature in a particular figure is not meant to imply that such feature is required in all embodiments and, in some embodiments, it may not be included or may be combined with other features.

### DETAILED DESCRIPTION

The following detailed description and examples set forth preferred materials, components, and procedures used in accordance with the present disclosure. This description and these examples, however, are provided by way of illustration only, and nothing therein shall be deemed to be a limitation upon the overall scope of the present disclosure.

An autonomous vehicle: An autonomous vehicle is a vehicle that is able to operate itself to perform various operations such as controlling or regulating acceleration, braking, steering wheel positioning, and so on, without any human intervention. An autonomous vehicle has an autonomy level of level-4 or level-5 recognized by National Highway Traffic Safety Administration (NHTSA).

A semi-autonomous vehicle: A semi-autonomous vehicle is a vehicle that is able to perform some of the driving related operations such as keeping the vehicle in lane and/or parking the vehicle without human intervention. A semi-autonomous vehicle has an autonomy level of level-1, level-2, or level-3 recognized by NHTSA.

A non-autonomous vehicle: A non-autonomous vehicle is a vehicle that is neither an autonomous vehicle nor a semi-autonomous vehicle. A non-autonomous vehicle has an autonomy level of level-0 recognized by NHTSA.

Advanced driver-assistance systems (ADAS): Advanced driver-assistance systems (ADAS) are systems in a vehicle that use sensors, cameras, and other technologies to assist the driver in performing driving tasks, such as collision avoidance, lane keeping, and adaptive cruise control. ADAS features operate at levels 0 to 2 of vehicle autonomy as recognized by NHTSA, providing support to the driver without full vehicle control or decision-making autonomy.

Semi-trucks frequently carry loads within trailers that extend the overall length of the vehicle, creating unique challenges when sharing the road with other vehicles. During certain maneuvers, such as wide turns, lane changes, or navigation through intersections, the trailer of a semi-truck can inadvertently create obstacles for other road users. For example, when executing a wide right turn, the trailer's path may encroach into adjacent lanes, blocking vehicles traveling in those lanes and forcing them to stop abruptly or risk a collision. Similarly, during left turns at intersections, the trailer may swing into cross-traffic or extend into the opposite side of the roadway, creating a temporary blockage that disrupts traffic flow. These scenarios are particularly problematic in urban environments or narrow roadways, where limited space amplifies the risk of collisions or impedes the ability of other vehicles to proceed safely along their intended routes.

Such incidents not only compromise the safety of surrounding drivers but also highlight the complexity of maneuvering semi-trucks with extended trailers in dynamic traffic environments. The inability of current systems to adequately monitor and mitigate these risks during critical maneuvers underscores the need for advanced technologies capable of detecting the proximity of vehicles or objects near the trailer. Addressing these challenges can ensure safer road sharing, minimize disruptions to traffic flow, and reduce the likelihood of collisions caused by the unintended movement or positioning of the trailer.

The disclosed systems and methods comprise an advanced trailer-mounted warning light system integrated with the ADAS functionality of a semi-truck, enabling enhanced safety signaling during maneuvers that pose risks to other roadway users. This system utilizes multiple sensors strategically positioned throughout the vehicle to continuously track the truck's environment, including the exact position, size, length, and angular orientation of the trailer. These sensors, combined with real-time localization and tracking capabilities, monitor the proximity of other vehicles or objects to the trailer and calculate areas of potential hazard.

The system's embedded software processes these inputs to determine situation-specific risks, such as a wide turn that encroaches on adjacent lanes, a blocked intersection caused by trailer positioning, or a narrow roadway passage where the trailer extends into another lane. Based on this data, the ADAS compute devices dynamically control trailer-mounted warning lights, activating specific sections to signal hazards to nearby roadway users. For instance, during a wide turn, the system enables lights along the affected side of the trailer, or in the case of encroachment onto a shoulder, the overlapping area is highlighted to alert oncoming traffic.

By dynamically adapting the activation of warning lights to specific scenarios, the disclosed system ensures that other drivers receive clear and precise visual cues, promoting safer interactions and mitigating the risk of collisions. This integration of ADAS technology with a configurable warning light system provides a solution for addressing safety challenges associated with trailer-induced obstacles on shared roadways.

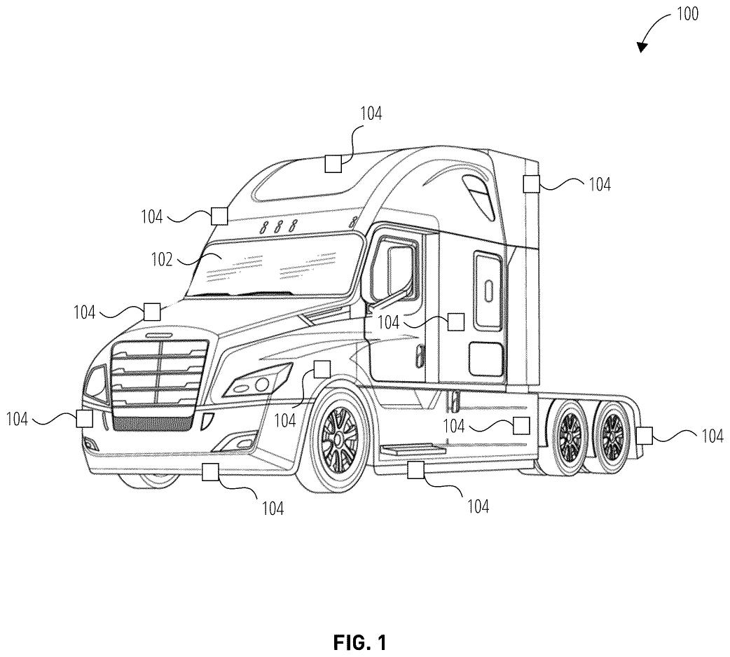

Various embodiments in the present disclosure are described with reference to FIGS. 1-7 below. Further, even though the embodiments are described for perception technologies used in autonomous vehicles, the embodiments described herein do not limit their scope to autonomous vehicles only and may be embodied in non-autonomous vehicles or semi-autonomous vehicles as well.

FIG. 1 illustrates an autonomous vehicle 100, such as a truck that may be conventionally connected to a single or tandem trailer to transport the trailer (not shown) to a desired location. The autonomous vehicle 100 includes a cabin that can be supported by, and steered in the required direction, by front wheels and rear wheels that are partially shown in FIG. 1. Front wheels are positioned by a steering system that includes a steering wheel and a steering column (not shown in FIG. 1). The steering wheel and the steering column may be located in the interior of cabin.

The autonomous vehicle 100 may be an autonomous vehicle, in which case the autonomous vehicle 100 may omit the steering wheel and the steering column to steer the autonomous vehicle 100. Rather, the autonomous vehicle 100 may be operated by an autonomy computing system (not shown) of the autonomous vehicle 100 based on data collected by a sensor network (not shown in FIG. 1) including one or more sensors.

In an example, the one or more sensors can include one or more cameras, LIDAR sensors, and radar sensors. These sensors can be strategically positioned on the semi-truck and its attached trailer to optimize coverage of the surrounding road environment. Cameras can capture visual data to identify objects, lane markings, and other vehicles, while LIDAR sensors provide precise three-dimensional mapping of the environment by emitting laser pulses to measure distances. Radar sensors are used to determine the speed, direction, and proximity of other vehicles, even in low-visibility conditions such as fog, rain, or nighttime driving.

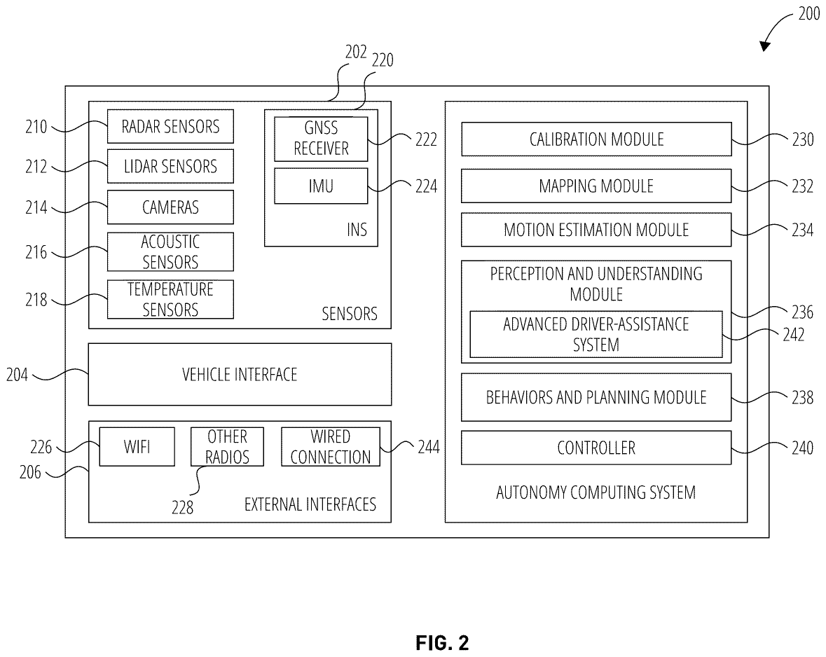

FIG. 2 is a block diagram of autonomous vehicle 100 shown in FIG. 1. In the example embodiment, autonomous vehicle 100 includes autonomy computing system 200, sensors 202, vehicle interface 204, and external interfaces 206.

In the example embodiment, sensors 202 may include various sensors such as, for example, radio detection and ranging (RADAR) sensors 210, light detection and ranging (LiDAR) sensors 212, cameras 214, acoustic sensors 216, temperature sensors 218, or inertial navigation system (INS) 220, which may include one or more global navigation satellite system (GNSS) receivers 222 and one or more inertial measurement units (IMU) 224. Other sensors 202 not shown in FIG. 2 may include, for example, acoustic (e.g., ultrasound), internal vehicle sensors, meteorological sensors, or other types of sensors. Sensors 202 generate respective output signals based on detected physical conditions of autonomous vehicle 100 and its proximity. As described in further detail below, these signals may be used by autonomy computing system 120 for lane segment detection or lane marking detection, or objection detection in the environment of autonomous vehicle 100.

Cameras 214 are configured to capture images of the environment surrounding autonomous vehicle 100 in any aspect or field of view (FOV). The FOV can have any angle or aspect such that images of the areas ahead of, to the side, behind, above, or below autonomous vehicle 100 may be captured. In some embodiments, the FOV may be limited to particular areas around autonomous vehicle 100 (e.g., forward of autonomous vehicle 100) or may surround 360 degrees of autonomous vehicle 100. In some embodiments, autonomous vehicle 100 includes multiple cameras 214, and the images from each of the multiple cameras 214 may be stitched or combined to generate a visual representation of the multiple cameras'FOVs, which may be used to, for example, generate a bird's-eye-view of the environment surrounding autonomous vehicle 100.

In some embodiments, cameras 214 may be stereo cameras to produce stereo images. Data of the stereo cameras 214 may be sent to autonomy computing system 200 or other aspects of autonomous vehicle 100 for stereo depth estimation. The stereo depth estimation may be used for computing disparity d for each pixel in the reference image. Disparity refers to the horizontal displacement between a pair of corresponding pixels on the left and right images of the stereo cameras 214. For the pixel (x, y) in the left image, if its corresponding point is found at (x−d, y) in the right image, then the depth of this pixel may be calculated by f*B/d, where f corresponds with a focal length of the camera, B corresponds with a baseline, and d corresponds with the distance between two camera centers of the stereo cameras 214.

Accordingly, stereo depth estimation requires identifying corresponding points in the left and right images based on matching cost and post-processing. By way of a non-limiting example, for a given rectified pair of images, the stereo depth estimation may be performed by advanced driver-assistance system 242, which computes multiscale descriptors for each image of the rectified pair of images with a pyramid encoder. The multiscale descriptors are then used to construct 4D feature volumes at each scale, by taking the difference of potentially matching features extracted from epipolar scanlines. Each feature volume may be decoded or filtered with 3D convolutions, making use of striding along the disparity dimensions to minimize the required memory resources. The decoded output may be used to predict 3D cost volumes that generate on-demand disparity estimates for the given scale and then upsampled to combine with the next feature volume in the pyramid. Additionally, or alternatively, in some embodiments, one or more systems or components of autonomy computing system 200 may overlay labels to the features depicted in the image data, such as on a raster layer or other semantic layer of a high-definition (HD) map.

LiDAR sensors 212 generally include a laser generator and a detector that send and receive a LiDAR signal such that LiDAR point clouds (or “LiDAR images”) of the areas ahead of, to the side, behind, above, or below autonomous vehicle 100 can be captured and represented in the LiDAR point clouds. RADAR sensors 210 may include short-range RADAR (SRR), mid-range RADAR (MRR), long-range RADAR (LRR), or ground-penetrating RADAR (GPR). One or more sensors may emit radio waves, and a processor may process received reflected data (e.g., raw radar sensor data) from the emitted radio waves. In some embodiments, the system inputs from cameras 214, RADAR sensors 210, or LiDAR sensors 212 may be fused, as described herein, by advanced driver-assistance system 242 to determine conditions (e.g., lane segmentation, lane marking detection, detection of other objects and their locations) around autonomous vehicle 100.

GNSS receiver 222 is positioned on autonomous vehicle 100 and may be configured to determine a location of autonomous vehicle 100, which it may embody as GNSS data, as described herein. GNSS receiver 222 may be configured to receive one or more signals from a global navigation satellite system (e.g., Global Positioning System (GPS) constellation) to localize autonomous vehicle 100 via geolocation. In some embodiments, GNSS receiver 222 may provide an input to or be configured to interact with, update, or otherwise utilize one or more digital maps, such as an HD map (e.g., in a raster layer or other semantic map). In some embodiments, GNSS receiver 222 may provide direct velocity measurement via inspection of the Doppler effect on the signal carrier wave. Multiple GNSS receivers 222 may also provide direct measurements of the orientation of autonomous vehicle 100. For example, with two GNSS receivers 222, two attitude angles (e.g., roll and yaw) may be measured or determined. In some embodiments, autonomous vehicle 100 is configured to receive updates from an external network (e.g., a cellular network). The updates may include one or more of position data (e.g., serving as an alternative or supplement to GNSS data), speed/direction data, orientation or attitude data, traffic data, weather data, or other types of data about autonomous vehicle 100 and its environment.

IMU 224 is a micro-electrical-mechanical (MEMS) device that measures and reports one or more features regarding the motion of autonomous vehicle 100, although other implementations are contemplated, such as mechanical, fiber-optic gyro (FOG), or FOG-on-chip (SiFOG) devices. IMU 224 may measure an acceleration, angular rate, and or an orientation of autonomous vehicle 100 or one or more of its individual components using a combination of accelerometers, gyroscopes, or magnetometers. IMU 224 may detect linear acceleration using one or more accelerometers and rotational rate using one or more gyroscopes and attitude information from one or more magnetometers. In some embodiments, IMU 224 may be communicatively coupled to one or more other systems, for example, GNSS receiver 222 and may provide input to and receive output from GNSS receiver 222 such that autonomy computing system 200 is able to determine the motive characteristics (acceleration, speed/direction, orientation/attitude, etc.) of autonomous vehicle 100.

In the example embodiment, autonomy computing system 200 employs vehicle interface 204 to send commands or data to the various aspects of autonomous vehicle 100 that actually control the motion of autonomous vehicle 100 (e.g., engine, throttle, steering wheel, brakes, etc.) and to receive input data from one or more sensors 202 (e.g., internal sensors). External interfaces 206 are configured to enable autonomous vehicle 100 to communicate with an external network via, for example, a wired or wireless connection, such as Wi-Fi 226 or other radios 228. In embodiments including a wireless connection, the connection may be a wireless communication signal (e.g., Wi-Fi, cellular, LTE, 5g, Bluetooth, etc.).

In some embodiments, external interfaces 206 may be configured to communicate with an external network via a wired connection 244, such as, for example, during testing of autonomous vehicle 100 or when downloading mission data after completion of a trip. The connection(s) may be used to download and install various lines of code in the form of digital files (e.g., HD maps), executable programs (e.g., navigation programs), and other computer-readable code that may be used by autonomous vehicle 100 to navigate or otherwise operate, either autonomously or semi-autonomously. The digital files, executable programs, and other computer readable code may be stored locally or remotely and may be routinely updated (e.g., automatically, or manually) via external interfaces 206 or updated on demand. In some embodiments, autonomous vehicle 100 may deploy with all of the data it needs to complete a mission (e.g., perception, localization, and mission planning) and may not utilize a wireless connection or other connection while underway.

In the example embodiment, autonomy computing system 200 is implemented by one or more processors and memory devices of autonomous vehicle 100. Autonomy computing system 200 includes modules, which may be hardware components (e.g., processors or other circuits) or software components (e.g., computer applications or processes executable by autonomy computing system 200), configured to generate outputs, such as control signals, based on inputs received from, for example, sensors 202. These modules may include, for example, a calibration module 230, a mapping module 232, a motion estimation module 234, a perception and understanding module 236, a behaviors and planning module 238, a control module or controller 240, and the advanced driver-assistance system 242.

The advanced driver-assistance system 242, for example, may be embodied within another module, such as perception and understanding module 236, or separately. Alternatively, the advanced driver-assistance system 242 may be embodied within the perception and understanding module 236. These modules may be implemented in dedicated hardware such as, for example, an application-specific integrated circuit (ASIC), field programmable gate array (FPGA), or microprocessor, or implemented as executable software modules or firmware, written to memory, and executed on one or more processors onboard autonomous vehicle 100. The advanced driver-assistance system (ADAS) improves precision and recall in detecting objects and vehicles within the vicinity of the semi-truck and its trailer, enabling accurate assessment of the trailer's position relative to its surroundings. This capability assists in making behavioral decisions, such as activating trailer-mounted warning lights during wide turns or lane encroachments, promoting safer maneuvers and interactions with other roadway users, and enhancing overall road safety while maintaining load stability and preventing aggressive maneuvers.

Autonomy computing system 200 of autonomous vehicle 100 may be completely autonomous (fully autonomous) or semi-autonomous. In one example, autonomy computing system 200 can operate under Level 5 autonomy (e.g., full driving automation), Level 4 autonomy (e.g., high driving automation), or Level 3 autonomy (e.g., conditional driving automation). As used herein the term “autonomous” includes both fully autonomous and semi-autonomous.

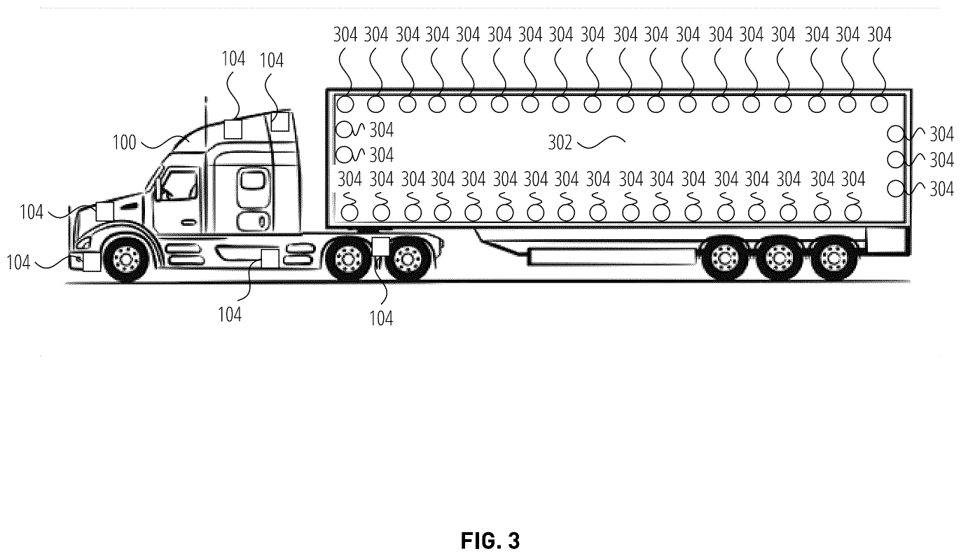

FIG. 3 illustrates an autonomous vehicle 100 connected to a trailer 302 configured to illuminate trailer-mounted warning lights 304 according to some aspects of the present disclosure.

The autonomous vehicle 100 is equipped with a plurality of sensors 104 that are positioned at various locations on the autonomous vehicle 100. These sensors 104 are configured to monitor the surrounding environment of autonomous vehicle 100 continuously, detecting objects and other vehicles in proximity to the autonomous vehicle 100 and its attached trailer 302. Trailer 302 is connected to the autonomous vehicle 100 via a series of wired connections, facilitating communication and control between the vehicle and the trailer.

Trailer 302 includes a plurality of trailer-mounted warning lights 304 strategically positioned on one or more side walls, rear wall, and top walls of trailer 302. These trailer-mounted warning lights 304 are configured to enhance visibility and provide real-time alerts to surrounding roadway users. The controller 240, illustrated in FIG. 2, within the autonomous vehicle 100 is configured to illuminate the trailer-mounted warning lights 304 in response to data received from one or more of the sensors 104. For instance, when one or more of the sensors 104 detect an approaching vehicle in close proximity to trailer 302, a determination is made by the advanced driver-assistance system 242, receiving data from sensors 104, that a collision is imminent, resulting in the controller activating the trailer-mounted warning lights 304.

In some examples, advanced driver-assistance system 242 may selectively illuminate only a portion of the trailer-mounted warning lights 304 based on a predicted risk area. For instance, the system can activate lights on a specific section of trailer 302 likely to be affected by a potential collision with another vehicle in proximity of the trailer 302 or obstructing the predicted path of the approaching vehicle.

The data collected by sensors 104 can be analyzed by the advanced driver-assistance system 242, illustrated in FIG. 2, to assess the movement and position of vehicles or objects relative to the autonomous vehicle 100 and trailer 302. For example, sensors 104 can identify vehicles approaching adjacent lanes during a wide turn or detect objects within the trailer's path when navigating narrow roadways. This collected data is pre-processed in real-time by controller 240 within autonomous vehicle 100, utilizing Sensor fusion.

Sensor fusion, performed by the controller, combines a plurality of data streams from the plurality of sensors to generate an organized object list. The object list provides a low-dimensional representation of detected objects, including their position (e.g., geographic coordinates, GPS location), size (length, height, and width), velocity, acceleration, and trajectory. By processing and condensing the raw sensor inputs, which may consist of gigabytes of images and data points, controller 240 can create a simplified view of the surrounding environment. Thus, advanced driver-assistance system 242 of the autonomous vehicle 100 can identify and track vehicles, obstacles, and road features along the route being navigated by autonomous vehicle 100.

Objects within the object list detected in the environment by sensors 104 are associated with specific positions on a digital map and real-time data from sensors 104. The digital map provides contextual information, such as lane widths, lane markings, and roadway features of the route being navigated by the autonomous vehicle 100. In more challenging conditions, such as construction zones or areas with missing or changing lane markings, the autonomous vehicle 100 relies more heavily on real-time sensor data from sensors 104. Conversely, high-definition offline maps are prioritized in well-mapped intersections or standard roadways to enhance accuracy.

Advanced driver-assistance system 242 can apply pre-processing techniques to eliminate false positives, such as environmental artifacts (e.g., rain, smoke, or debris), that might otherwise result in the creation of ghost objects that should not be included in the object list. Objects to include in the object list are confirmed after a continuous detection threshold is met over a predetermined time interval.

The object list is further used to predict potential collision risks involving trailer 302. By identifying the trajectory and speed of nearby vehicles, advanced driver-assistance system 242 can determine which parts of trailer 302 are likely to be impacted and activate targeted trailer-mounted warning lights 304 associated with the determined parts of trailer 302.

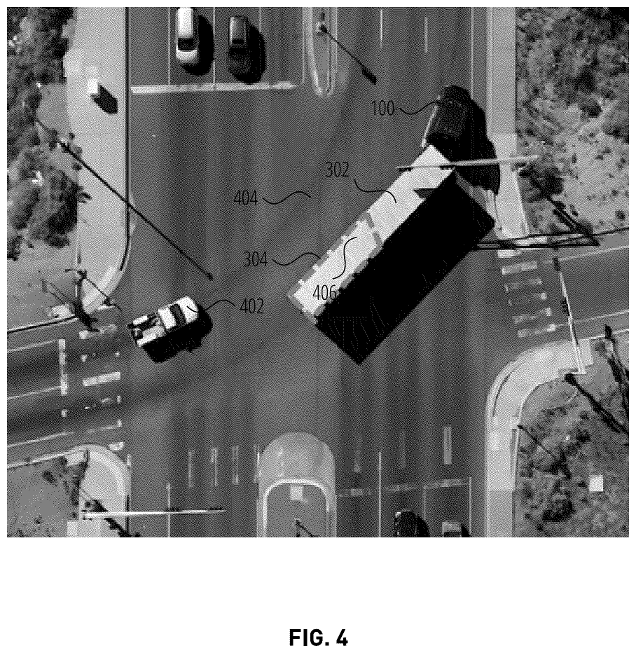

FIG. 4 illustrates an example left turn maneuver of an autonomous vehicle causing the illumination of warning lights of a connected trailer to alert a vehicle within close proximity according to some aspects of the present technology.

FIG. 4 illustrates an autonomous vehicle 100 performing a left-turn maneuver at an intersection 404. Intersection 404 presents a challenging environment with multiple vehicles, including stationary vehicles waiting at a traffic light and vehicles navigating their own turning maneuvers. Autonomous vehicle 100, with attached trailer 302, must account for a size of trailer 302, the required turning radius, and other vehicles in proximity, such as vehicle 402, which poses a potential collision risk.

In some examples, intersections can be inherently complex for autonomous vehicles due to the density of traffic users and the unpredictability of their movements. During the left turn, sensors 104, illustrated in FIG. 1, on the autonomous vehicle 100, can continuously monitor the surrounding environment. Sensors 104 collect detailed data about the lane markings, road geometry, the position of trailer 302, and the motion and direction of nearby vehicles.

As autonomous vehicle 100 navigates the turn, the sensors 104 and advanced driver-assistance system 242, illustrated in FIG. 2, determine a turn angle of trailer 302, dimensions of trailer 302, and position of trailer 302 within the intersection. If trailer 302 partially obstructs intersection 404 due to the turning radius, advanced driver-assistance system 242 uses the object list and high-definition map data to compute the specific portion of the trailer at risk of collision with nearby vehicles, such as vehicle 402. Advanced driver-assistance system 242 identifies that the predicted path and trajectory of vehicle 402 is likely to intersect with trailer 302, posing a collision risk with a portion of trailer 302.

To mitigate this risk, advanced driver-assistance system 242 activates trailer-mounted warning lights 304 on the specific section 406 of trailer 302 that is identified as being at risk. The warning lights provide a targeted visual alert to vehicle 402, communicating the hazard and prompting the driver or the vehicle's system to adjust its trajectory or stop to avoid a collision.

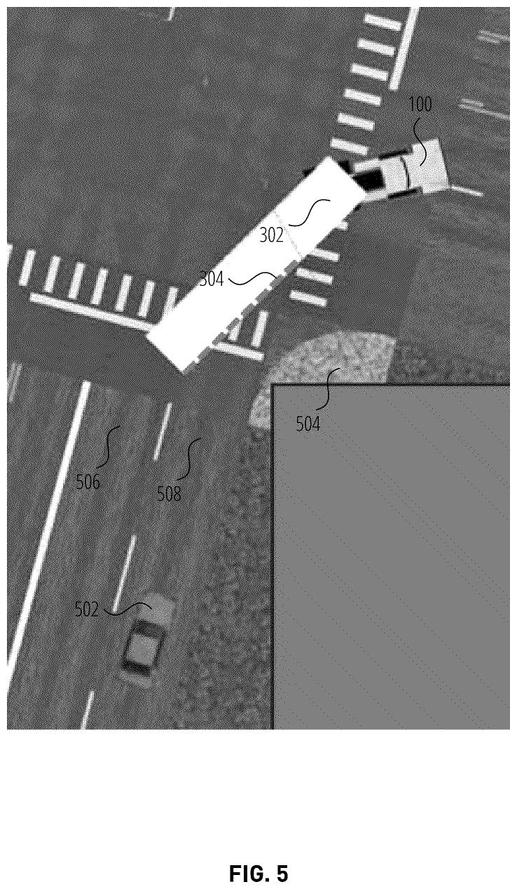

FIG. 5 illustrates an example right turn maneuver of an autonomous vehicle causing the illumination of warning lights of a connected trailer to alert a vehicle within close proximity according to some aspects of the present technology.

During the right turn maneuver, autonomous vehicle 100 must accommodate the size and turning radius of trailer 302, often requiring a wider turn to safely traverse a curb 504. As a result, the turning action causes trailer 302 to encroach on both travel lane 1 506 and travel lane 2 508, temporarily blocking portions of the roadway.

While autonomous vehicle 100 is executing the turn, sensors 104, as illustrated in FIG. 1, continuously monitor the surrounding environment, collecting real-time data about objects and vehicles in proximity of trailer 302 while performing the right turn maneuver. During the turn, vehicle 502 is detected traveling along travel lane 2 508 at a determined speed and trajectory towards autonomous vehicle 100 and trailer 302. Based on this sensor data, advanced driver-assistance system 242 evaluates the positional relationship between vehicle 502 and trailer 302.

Advanced driver-assistance system 242 determines that due to the angle and position of trailer 302 during the turn, travel lane 2 508 is fully obstructed, and travel lane 1 506 is partially blocked. Advanced driver-assistance system 242 predicts that the trajectory of vehicle 502 is likely to intersect with the path of trailer 302, creating a high risk of collision. Using this information, the advanced driver-assistance system 242 identifies the specific portion of the trailer that is obstructing travel lane 2 508 and poses a hazard to vehicle 502.

To mitigate the risk and alert vehicle 502 of the obstruction, advanced driver-assistance system 242 illuminates a targeted section of the trailer-mounted warning lights 304. These illuminated warning lights correspond to the area of the trailer blocking travel lane 2 508 and align with the predicted path of vehicle 502.

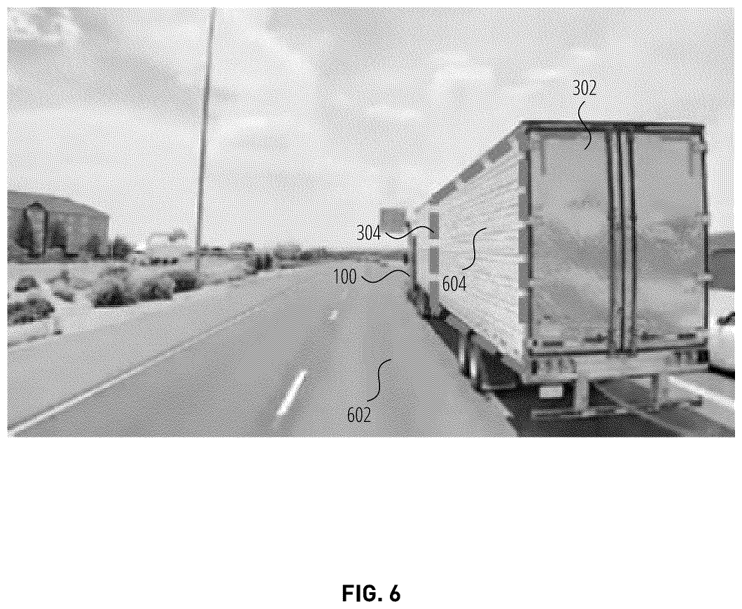

FIG. 6 illustrates an example lane change maneuver of an autonomous vehicle causing the illumination of warning lights of a connected trailer to alert a vehicle within close proximity according to some aspects of the present technology.

In some examples, the lane change maneuver can be initiated by autonomous vehicle 100 to comply with a planned route, such as preparing for a highway exit or merging onto a different roadway segment. The lane change maneuver can involve coordination between the autonomous vehicle 100 and its connected trailer 302 to ensure safe execution without interfering with nearby vehicles.

As the lane change is initiated, sensors 104 mounted on the autonomous vehicle 100 and trailer 302, as described in FIG. 1, continuously monitor the surrounding environment. Sensors 104 can collect data on lane markings, adjacent lanes, such as adjacent travel lane 602, and the presence and movement of other vehicles. Based on the data received, advanced driver-assistance system 242, illustrated in FIG. 2, processes the information to assess the position and the proximity of vehicles in adjacent travel lane 602 to trailer 302.

During the lane change maneuver, the advanced driver-assistance system 242 determines that a portion of trailer 302, specifically section 604, may encroach into the adjacent travel lane 602 as it aligns with the movement of the autonomous vehicle 100. If a vehicle is detected within close proximity in adjacent travel lane 602, the advanced driver-assistance system 242 evaluates the trajectory and speed of the detected vehicle and identifies the potential risk of a collision with section 604 of the trailer. Depending on the determined position of a vehicle, the trailer-mounted warning lights 304 can dynamically reduce or extend the section 604 of trailer 302 that has illuminated trailer-mounted warning lights 304.

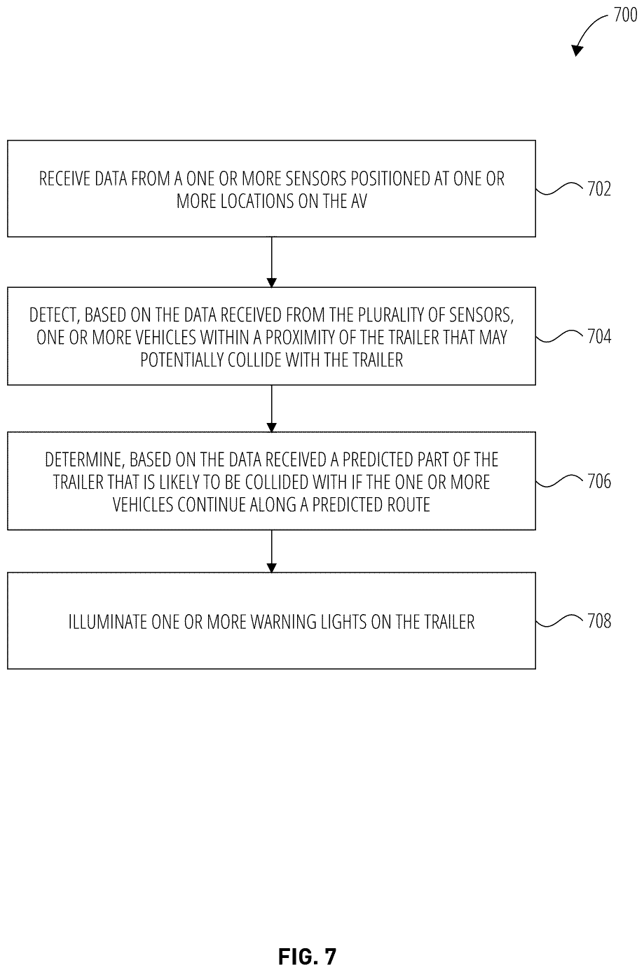

FIG. 7 is a flow diagram of an example embodiment method for alerting vehicles in proximity of a trailer of an autonomous vehicle (AV) according to some aspects of the present disclosure. Although the example routine 700 depicts a particular sequence of operations, the sequence may be altered without departing from the scope of the present disclosure. For example, some of the operations depicted may be performed in parallel or in a different sequence that does not materially affect the function of the routine 700. In other examples, different components of an example device or system that implements the routine 700 may perform functions at substantially the same time or in a specific sequence.

According to some examples, the method includes receiving data from a one or more sensors positioned at one or more locations on the AV at block 702. For example, the advanced driver-assistance system 242 illustrated in FIG. 2 may receive data from a plurality of sensors positioned at various locations on the autonomous vehicle (AV). These sensors are configured to detect objects, including vehicles, within the surrounding areas of the trailer as the AV navigates a route. The data collected by the sensors is processed and fused to generate an object list, which includes critical information about detected objects, such as their position, dimensions, velocity, acceleration, and trajectory. The object list is stored in a low-dimensional format to optimize processing efficiency, retaining only essential attributes like geographic coordinates, size, and motion characteristics.

In some examples, each object in the object list is associated with a corresponding position on a digital map, which may include detailed lane-level data, lane widths, and other roadway features. This contextual mapping allows the system to accurately assess collision risks by determining the relative proximity and alignment of detected objects to specific sections of the trailer. The generation of the object list incorporates pre-processing and filtering techniques to remove false positives caused by environmental noise, such as adverse weather conditions, smoke, or other anomalies, reducing the likelihood of ghost objects being included.

In some examples, the object list data is further integrated with predictive models that estimate the future positions and behaviors of detected objects. This predictive capability enables the system to dynamically activate warning lights on the trailer, targeting specific sections at risk of collision, thereby proactively alerting nearby vehicles, and minimizing the potential for accidents.

According to some examples, the method includes detecting, based on the data received from the plurality of sensors, one or more vehicles within a proximity of the trailer that may potentially collide with the trailer at block 704. For example, the advanced driver-assistance system 242 illustrated in FIG. 2 may detect one or more vehicles within a proximity of the trailer that present a potential risk of collision, based on data received from a plurality of sensors positioned on the AV. The one or more sensors can continuously monitor the surrounding environment, capturing detailed information about nearby vehicles and objects. The received data can include parameters for each detected vehicle, such as each vehicles current trajectory, speed, and predicted direction. The ADAS can further perform an analysis of the received data in real-time to assess the relative motion and spatial relationship of the vehicles in the surrounding areas of the trailer.

According to some examples, the method includes determining, based on the data received a predicted part of the trailer that is likely to be collided with if the one or more vehicles continue along a predicted route at block 706. For example, the advanced driver-assistance system 242 illustrated in FIG. 2 may determine, based on the data received a predicted part of the trailer that is likely to be collided with if the one or more vehicles continue along a predicted route.

According to some examples, the method includes illuminating one or more warning lights on the trailer at block 708. For example, the advanced driver-assistance system 242 illustrated in FIG. 2 may activate one or more warning lights on the trailer. The activated warning lights correspond to the specific section of the trailer predicted to be at risk of collision with one or more vehicles. The activation process involves selectively illuminating only the lights associated with the part of the trailer that is obstructing or encroaching on the path of a detected vehicle.

In some examples, advanced driver-assistance system 242 may adjust the brightness or color of the warning lights based on the proximity, speed, or trajectory of the detected vehicle. Vehicles that are closer or pose an immediate risk trigger more prominent illumination. The warning lights can also be dynamically activated as the trailer moves through intersections or encroaches into adjacent lanes, with the illumination corresponding to the real-time position of the trailer.

In some examples, the warning lights are automatically triggered when the trailer is detected to obstruct a roadway, an intersection, or a lane based on the positional data of the autonomous vehicle and its trailer. The system may also include a gradient effect, where variations in color or brightness indicate the extent to which the trailer encroaches into a roadway or the level of collision risk.

In some instances, such as when the trailer is stationary or moving at low speed while partially obstructing traffic, the system enables continuous illumination of all warning lights to enhance visibility. The functionality of the warning lights can be further adapted to include additional visual indicators, such as directional arrows or blinking patterns, to convey specific safety information to nearby vehicles effectively.

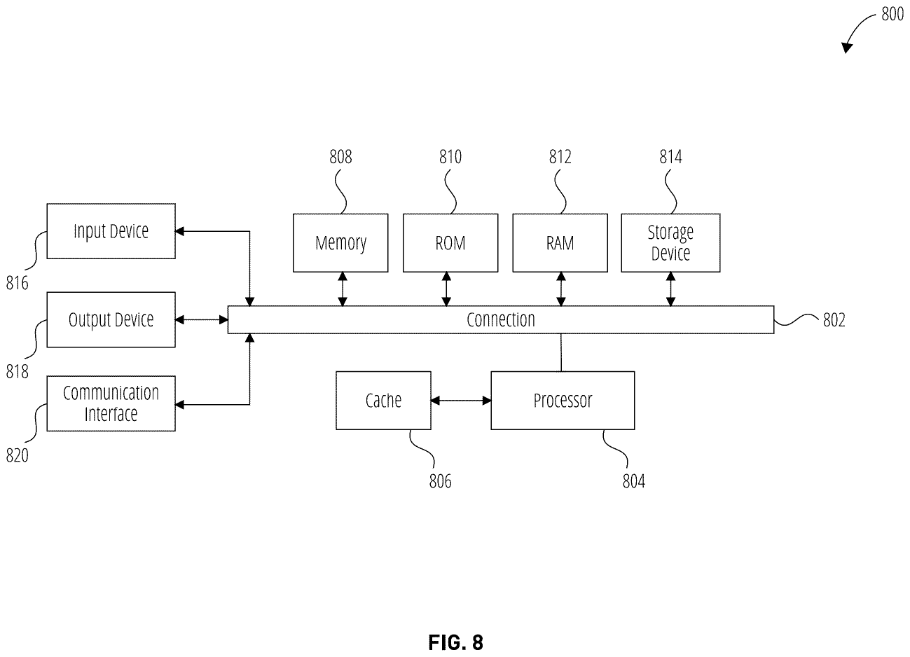

FIG. 8 illustrates an example computing system 800 that can implement various techniques, processes, functions, or methods described herein. The components of computing system 800 are shown in electrical communication with each other using a connection 802, such as a bus. The example computing system 800 includes a processing unit (or processor) 804 and a computing device connection 802 that couples various computing device components, including computing device memory 808, such as a read-only memory ROM 810 and a random access memory RAM 812, to processor 804.

Computing system 800 can include a cache 806 of high-speed memory connected directly with, in close proximity to, or integrated as part of processor 804. Computing system 800 can copy data from memory 808 and/or storage device 814 to cache 806 for quick access by processor 804. In this way, cache 806 can provide a performance boost that avoids processor 804 delays while waiting for data. These and other modules can control or be configured to control processor 804 to perform various actions. Other computing device memory 808 may be available for use as well. Memory 808 can include multiple different types of memory with different performance characteristics. Processor 804 can include any general purpose processor, central processing unit (CPU), or graphics processing unit (GPU) in combination with a hardware or software provision configured to control processor 804 and stored in storage device 814, as well as any special-purpose processor where software instructions are incorporated into the processor design. Processor 804 may be a self-contained system, containing multiple cores or processors, a bus, memory controller, cache, etc. A multi-core processor may be symmetric or asymmetric.

Storage device 814 is a non-volatile memory and can be one or more of a hard disk or other types of computer readable media that can store data that are accessible by a computer, such as a magnetic cassette, flash memory card, solid state memory device, digital versatile disk, cartridge, RAM 812, ROM 810, or hybrids thereof. Memory 808 or storage device 814 can include software, code, firmware, etc., for controlling processor 804. Other hardware or software modules are contemplated. Memory 808 and storage device 814 are connected to computing device connection 802. In one aspect, a hardware module that performs a particular function can include the software component stored in a computer-readable medium in connection with the necessary hardware components, such as processor 804, computing device connection 802, and so forth, to carry out the function. In the example embodiment, processor 804 may be programmed by encoding an operation or function using one or more executable instructions and providing the executable instructions in memory 808 or storage device 814.

To enable user interaction, computing system 800 includes an input device 816, which can represent any number of input mechanisms, such as a microphone for speech, a touch-sensitive screen for gesture or graphical input, keyboard, mouse, motion input, speech, etc. Computing system 800 can also include output device 818, which can be one or more of a number of output mechanisms known to those of skill in the art. In some instances, multimodal systems can enable a user to provide multiple types of input/output to communicate with computing system 800. Computing system 800 can include communication interface 820, which can generally govern and manage the user input and system output. There is no restriction on operating on any particular hardware arrangement, and therefore the basic features here may easily be substituted for improved hardware or firmware arrangements as they are developed.

In operation, a computer executes computer-executable instructions embodied in one or more computer-executable components stored on one or more computer-readable media to implement aspects of the disclosure described or illustrated herein. The order of execution or performance of the operations in embodiments of the disclosure illustrated and described herein is not essential, unless otherwise specified. That is, the operations may be performed in any order, unless otherwise specified, and embodiments of the disclosure may include additional or fewer operations than those disclosed herein. For example, it is contemplated that executing or performing a particular operation before, contemporaneously with, or after another operation is within the scope of aspects of the disclosure.

An example technical effect of the methods, systems, and apparatus described herein includes at least one of: (a) enhancing vehicle safety by utilizing sensors positioned on the autonomous vehicle to detect surrounding vehicles near the trailer; (b) predicting potential collision risks by analyzing the trajectory, speed, and position of surrounding vehicles relative to specific parts of the trailer; and (c) dynamically activating targeted warning lights on the trailer to visually alert nearby vehicles, thereby mitigating collision risks and promoting safer road interactions.

Some embodiments involve the use of one or more electronic processing or computing devices. As used herein, the terms “processor” and “computer” and related terms, e.g., “processing device,” and “computing device” are not limited to just those integrated circuits referred to in the art as a computer, but broadly refers to a processor, a processing device or system, a general purpose central processing unit (CPU), a graphics processing unit (GPU), a microcontroller, a microcomputer, a programmable logic controller (PLC), a reduced instruction set computer (RISC) processor, a field programmable gate array (FPGA), a digital signal processor (DSP), an application specific integrated circuit (ASIC), and other programmable circuits or processing devices capable of executing the functions described herein, and these terms are used interchangeably herein. These processing devices are generally “configured” to execute functions by programming or being programmed, or by the provisioning of instructions for execution. The above examples are not intended to limit in any way the definition or meaning of the terms processor, processing device, and related terms.

The various aspects illustrated by logical blocks, modules, circuits, processes, algorithms, and algorithm steps described above may be implemented as electronic hardware, software, or combinations of both. Certain disclosed components, blocks, modules, circuits, and steps are described in terms of their functionality, illustrating the interchangeability of their implementation in electronic hardware or software. The implementation of such functionality varies among different applications given varying system architectures and design constraints. Although such implementations may vary from application to application, they do not constitute a departure from the scope of this disclosure.

Aspects of embodiments implemented in software may be implemented in program code, application software, application programming interfaces (APIs), firmware, middleware, microcode, hardware description languages (HDLs), or any combination thereof. A code segment or machine-executable instruction may represent a procedure, a function, a subprogram, a program, a routine, a subroutine, a module, a software package, a class, or any combination of instructions, data structures, or program statements. A code segment may be coupled to, or integrated with, another code segment or an electronic hardware by passing or receiving information, data, arguments, parameters, memory contents, or memory locations. Information, arguments, parameters, data, etc. may be passed, forwarded, or transmitted via any suitable means including memory sharing, message passing, token passing, network transmission, etc.

The actual software code or specialized control hardware used to implement these systems and methods is not limiting of the claimed features or this disclosure. Thus, the operation and behavior of the systems and methods were described without reference to the specific software code being understood that software and control hardware can be designed to implement the systems and methods based on the description herein.

When implemented in software, the disclosed functions may be embodied, or stored, as one or more instructions or code on or in memory. In the embodiments described herein, memory includes non-transitory computer-readable media, which may include, but is not limited to, media such as flash memory, a random access memory (RAM), read-only memory (ROM), erasable programmable read-only memory (EPROM), electrically erasable programmable read-only memory (EEPROM), and non-volatile RAM (NVRAM). As used herein, the term “non-transitory computer-readable media” is intended to be representative of any tangible, computer-readable media, including, without limitation, non-transitory computer storage devices, including, without limitation, volatile and non-volatile media, and removable and non-removable media such as a firmware, physical and virtual storage, CD-ROM, DVD, and any other digital source such as a network, a server, cloud system, or the Internet, as well as yet to be developed digital means, with the sole exception being a transitory propagating signal. The methods described herein may be embodied as executable instructions, e.g., “software” and “firmware,” in a non-transitory computer-readable medium. As used herein, the terms “software” and “firmware” are interchangeable and include any computer program stored in memory for execution by personal computers, workstations, clients, and servers. Such instructions, when executed by a processor, configure the processor to perform at least a portion of the disclosed methods.

As used herein, an element or step recited in the singular and proceeded with the word “a” or “an” should be understood as not excluding plural elements or steps unless such exclusion is explicitly recited. Furthermore, references to “one embodiment” of the disclosure or an “exemplary” or “example” embodiment are not intended to be interpreted as excluding the existence of additional embodiments that also incorporate the recited features. Likewise, limitations associated with “one embodiment” or “an embodiment” should not be interpreted as limiting to all embodiments unless explicitly recited.

Disjunctive language such as the phrase “at least one of X, Y, or Z,” unless specifically stated otherwise, is generally intended, within the context presented, to disclose that an item, term, etc. may be either X, Y, or Z, or any combination thereof (e.g., X, Y, and/or Z). Likewise, conjunctive language such as the phrase “at least one of X, Y, and Z,” unless specifically stated otherwise, is generally intended, within the context presented, to disclose at least one of X, at least one of Y, and at least one of Z.

Although certain embodiments have been illustrated and described herein for purposes of description, a wide variety of alternate and/or equivalent embodiments or implementations calculated to achieve the same purposes may be substituted for the embodiments shown and described without departing from the scope of the present disclosure. This application is intended to cover any adaptations or variations of the embodiments discussed herein, including the implementation or utilization of components of the systems or steps independently and separately from other described components or steps. Therefore, it is manifestly intended that embodiments described herein be limited only by the claims.

What is claimed is:

1. A computing system for alerting vehicles in proximity of a trailer of an autonomous vehicle (AV), the system comprising:
at least one memory configured to store machine-executable instructions; and
at least one processor coupled to the at least one memory and configured to execute the machine-executable instructions to:
receive data from a one or more sensors positioned at one or more locations on the AV, the one or more sensors configured to detect one or more vehicles in surrounding areas of the trailer of the AV as the AV is navigating a route;
detect, based on the data received from the one or more sensors, one or more vehicles within a proximity of the trailer that may potentially collide with the trailer;
determine, based on the data received a predicted part of the trailer that is likely to be collided with if the one or more vehicles continue along a predicted route; and
illuminate one or more warning lights on the trailer, wherein the illuminated warning lights correspond to the predicted part of the trailer that is likely to be collided with by the one or more vehicles.

2. The computing system of claim 1, wherein the data received for the one or more vehicles in surrounding areas includes a trajectory, a speed, and a predicted direction of the one or more vehicles.

3. The computing system of claim 1, wherein the illuminating of the one or more warning lights comprises selectively illuminating only the warning lights corresponding to the part of the trailer that is predicted to be obstructing a path of a detected vehicle.

4. The computing system of claim 3, wherein the at least one processor is further configured to:
adjust an intensity or color of the illuminated warning lights based on the proximity, velocity, or trajectory of the detected vehicle, wherein closer or more imminent collisions result in more prominent illumination.

5. The computing system of claim 1, wherein the at least one processor is further configured to:
dynamically activating warning lights as the trailer moves through an intersection or across lanes, wherein the illumination corresponds to a real-time position of the trailer and any part of the trailer that is obstructing or encroaching into a path of other vehicles.

6. The computing system of claim 1, wherein the illuminating of the warning lights is triggered automatically when the trailer is detected to be obstructing a roadway, an intersection, or an adjacent lane based on the positional data of the autonomous vehicle and the trailer.

7. The computing system of claim 1, wherein the warning lights are configured to display a gradient effect, with variations in color or brightness indicating a degree to which a part of the trailer is encroaching into a roadway or posing a potential collision risk.

8. An autonomous vehicle (AV), comprising:
one or more tires;
at least one or more sensors configured to collect data related to one or more vehicles in an environment surrounding the AV;
a memory configured to store machine executable instructions; and
at least one processor configured to execute the stored executable instructions to:
receive data from a one or more sensors positioned at one or more locations on the AV, the one or more sensors configured to detect one or more vehicles in surrounding areas of a trailer of the AV as the AV is navigating a route;
detect, based on the data received from the one or more sensors, the one or more vehicles within a proximity of the trailer that may potentially collide with the trailer;
determine, based on the data received a predicted part of the trailer that is likely to be collided with if the one or more vehicles continue along a predicted route; and
illuminate one or more warning lights on the trailer, wherein the illuminated warning lights correspond to the predicted part of the trailer that is likely to be collided with by the one or more vehicles.

9. The AV of claim 8, wherein the data received for the one or more vehicles in surrounding areas includes a trajectory, a speed, and a predicted direction of the one or more vehicles.

10. The AV of claim 8, wherein the illuminating of the one or more warning lights comprises selectively illuminating only the warning lights corresponding to the part of the trailer that is predicted to be obstructing a path of a detected vehicle.

11. The AV of claim 10, wherein the at least one processor is further configured to:
adjust an intensity or color of the illuminated warning lights based on the proximity, velocity, or trajectory of the detected vehicle, wherein closer or more imminent collisions result in more prominent illumination.

12. The AV of claim 8, wherein the at least one processor is further configured to:
dynamically activating warning lights as the trailer moves through an intersection or across lanes, wherein the illumination corresponds to a real-time position of the trailer and any part of the trailer that is obstructing or encroaching into a path of other vehicles.

13. The AV of claim 8, wherein the illuminating of the warning lights is triggered automatically when the trailer is detected to be obstructing a roadway, an intersection, or an adjacent lane based on the positional data of the autonomous vehicle and the trailer.

14. The AV of claim 8, wherein the warning lights are configured to display a gradient effect, with variations in color or brightness indicating a degree to which a part of the trailer is encroaching into a roadway or posing a potential collision risk.

15. A method comprising:
receiving data from a one or more sensors positioned at one or more locations on an autonomous vehicle (AV), the one or more sensors configured to detect one or more vehicles in surrounding areas of a trailer of the AV as the AV is navigating a route;
detecting, based on the data received from the one or more sensors, one or more vehicles within a proximity of the trailer that may potentially collide with the trailer;
determining, based on the data received a predicted part of the trailer that is likely to be collided with if the one or more vehicles continue along a predicted route; and
illuminating one or more warning lights on the trailer, wherein the illuminated warning lights correspond to the predicted part of the trailer that is likely to be collided with by the one or more vehicles.

16. The method of claim 15, wherein the data received for the one or more vehicles in surrounding areas includes a trajectory, a speed, and a predicted direction of the one or more vehicles.

17. The method of claim 15, wherein the illuminating of the one or more warning lights comprises selectively illuminating only the warning lights corresponding to the part of the trailer that is predicted to be obstructing a path of a detected vehicle.

18. The method of claim 17, further comprising:
adjusting an intensity or color of the illuminated warning lights based on the proximity, velocity, or trajectory of the detected vehicle, wherein closer or more imminent collisions result in more prominent illumination.

19. The method of claim 15, further comprising:
dynamically activating warning lights as the trailer moves through an intersection or across lanes, wherein the illumination corresponds to a real-time position of the trailer and any part of the trailer that is obstructing or encroaching into a path of other vehicles.

20. The method of claim 15, wherein the illuminating of the warning lights is triggered automatically when the trailer is detected to be obstructing a roadway, an intersection, or an adjacent lane based on the positional data of the AV and the trailer.
